(19) United States
(12) Patent Application Publication
(10) Pub. No.: US 2026/0258631 A1
(43) Pub. Date: Sep. 3, 2026

(54) CONTROL SYSTEM FOR WORK MACHINE AND CONTROL METHOD FOR WORK MACHINE

(71) Applicant: KOMATSU LTD., Tokyo (JP)

(72) Inventor: Toyohito Uchizono, Tokyo (JP)

(73) Assignee: KOMATSU LTD., Tokyo (JP)

(21) Appl. No.: 19/148,704

(22) PCT Filed: Feb. 2, 2024
(86) PCT No.: PCT/JP2024/003446

§ 371 Date: Jul. 17, 2025

(30) Foreign Application Priority Data
Feb. 24, 2023 (JP) 2023-026915

(51) Int. Cl. E02F 9/12; E02F 3/32; E02F 3/43; E02F 9/20

(52) U.S. Cl. CPC E02F 9/123; E02F 3/32; E02F 3/439; E02F 9/128; E02F 9/2004

(57) ABSTRACT

A control system for a work machine includes: a revolving body; an operation device operated to revolve the revolving body; a revolving parking brake that can stop revolving of the revolving body; an automatic control command generator that outputs an automatic control command for automatically controlling the revolving body; and a brake controller that controls the revolving parking brake based on an operation state of the operation device or an output state of the automatic control command.

### TECHNICAL FIELD

The present disclosure relates to a control system for a work machine and a control method for a work machine.

### BACKGROUND ART

In a technical field related to work machines, there is a known work machine in which a series of operations from excavation to soil removal is automatically controlled as disclosed in Patent Document 1. A work machine including a revolving parking brake that can stop revolving of a revolving body is known.

### CITATION LIST

### Patent Document

Patent Document 1: JP 2021-011694 A SUMMARY OF INVENTION

### Technical Problem

In manual operation of a revolving body, the operator operates an operation lever for revolving a revolving body. The revolving body revolves based on the operation of the operation lever. There is a known technique in which a revolving parking brake is automatically activated when the operation lever has been in a neutral state for a predetermined time. Once automatic control of the revolving body is started, it is highly likely that the operator does not move the operation lever or releases the hand from the operation lever. That is, once automatic control of the revolving body is started, it is highly likely that the operation lever is brought into the neutral state. In automatic control of the revolving body, it is likely that the revolving parking brake is activated when the operation lever has been in a neutral state for a predetermined time. As a result, it is likely that the work efficiency of the work machine decreases.

An object of the present disclosure is to suppress a decrease in work efficiency.

### Solution to Problem

According to the present disclosure, there is provided a control system for a work machine including: a revolving body; an operation device operable to revolve the revolving body; a revolving parking brake configured to stop revolving of the revolving body; an automatic control command unit configured to output an automatic control command for automatically controlling the revolving body; and a brake control unit configured to control the revolving parking brake based on an operation state of the operation device or an output state of the automatic control command.

### Advantageous Effects of Invention

According to the present disclosure, a decrease in work efficiency is suppressed.

### BRIEF DESCRIPTION OF DRAWINGS

FIG. 1 is a perspective view illustrating a work machine according to an embodiment.

FIG. 2 is a schematic view illustrating the work machine according to the embodiment.

FIG. 3 is a view illustrating a cab of the work machine according to the embodiment.

FIG. 4 is a diagram for describing operation of the work machine according to the embodiment.

FIG. 5 is a diagram for describing operation of the work machine according to the embodiment.

FIG. 6 is a view for describing a teaching process of setting a down revolving target position and a hoist revolving target position according to the embodiment.

FIG. 7 is a block diagram illustrating a control system for the work machine according to the embodiment.

FIG. 8 is a diagram for describing determination as to whether automatic control is possible and switching of an operation mode according to the embodiment.

FIG. 9 is a flowchart showing a control method for the work machine according to the embodiment.

FIG. 10 is a block diagram illustrating a computer system according to the embodiment.

FIG. 11 is a block diagram illustrating a part of a control system of a work machine according to another embodiment.

FIG. 12 is a block diagram illustrating a part of a control system of a work machine according to another embodiment.

FIG. 13 is a schematic view illustrating a remote operation system of a work machine according to another embodiment.

### DESCRIPTION OF EMBODIMENTS

Hereinafter, embodiments according to the present disclosure will be described with reference to the drawings, but the present disclosure is not limited to the embodiments. Components of the embodiments described below can be combined as appropriate. Some components are not used in some cases.

### Work Machine

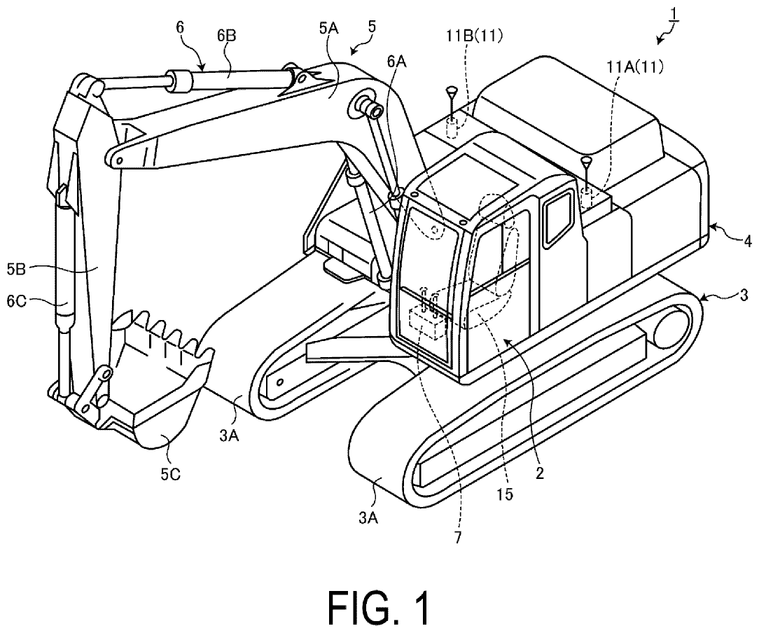

FIG. 1 is a perspective view illustrating a work machine 1 according to an embodiment.

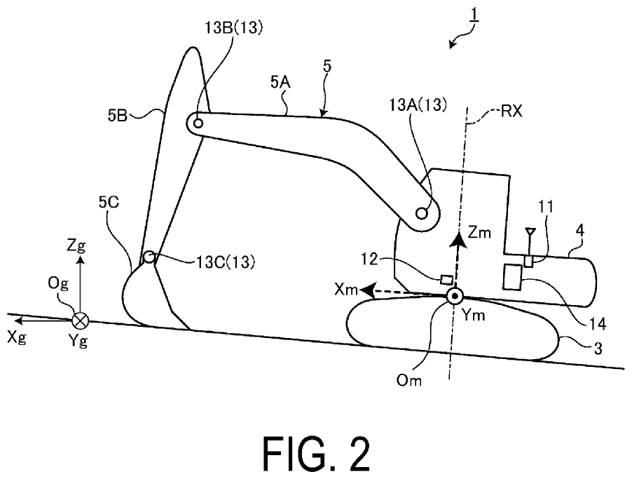

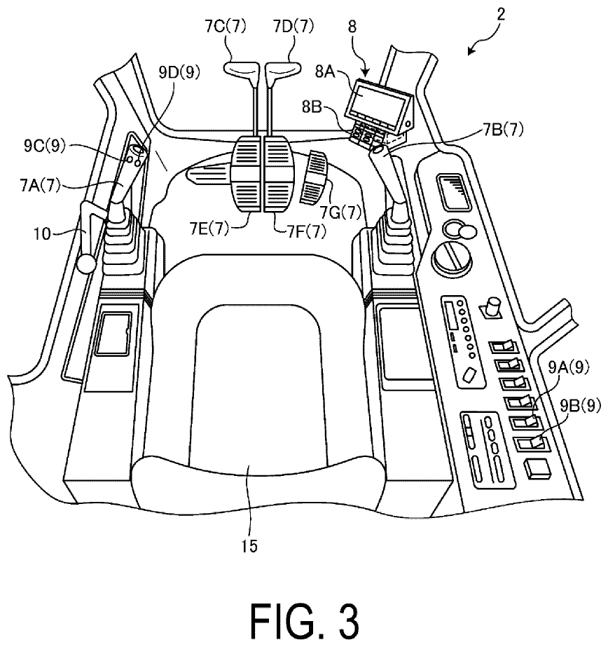

FIG. 2 is a schematic view illustrating the work machine 1 according to the embodiment. FIG. 3 is a view illustrating a cab 2 of the work machine 1 according to the embodiment.

The work machine 1 operates at a work site. In the embodiment, the work machine 1 is a hydraulic excavator. In the following description, the work machine 1 is appropriately referred to as a hydraulic excavator 1.

The hydraulic excavator 1 includes a traveling body 3, a revolving body 4, a work implement 5, a hydraulic cylinder 6, an operation device 7, an in-vehicle monitor 8, an input device 9, a lock lever 10, a position sensor 11, an inertial sensor 12, a posture sensor 13, and a control device 14.

As illustrated in FIG. 2, a three-dimensional site coordinate system (Xg, Yg, Zg) is defined at the work site. A three-dimensional vehicle body coordinate system (Xm, Ym, Zm) is defined at the revolving body 4.

The site coordinate system includes an Xg axis extending north-south from a site reference point Og defined at the work site, a Yg axis extending east-west from the site reference point Og, and a Zg axis extending up-down from the site reference point Og. In the embodiment, the site coordinate system is a global coordinate system.

The vehicle body coordinate system includes an Xm axis extending in a front-rear direction of the revolving body 4 from a representative point Om defined at the revolving body 4, a Ym axis extending in a left-right direction of the revolving body 4 from the representative point Om, and a Zm axis extending in an up-down direction of the revolving body 4 from the representative point Om. With reference to the representative point Om of the revolving body 4, a +Xm direction is the front of the revolving body 4, a −Xm direction is the rear of the revolving body 4, a +Ym direction is the left of the revolving body 4, a −Ym direction is the right of the revolving body 4, a +Zm direction is above the revolving body 4, and a −Zm direction is below the revolving body 4.

The traveling body 3 travels in a state of supporting the revolving body 4. The traveling body 3 includes a pair of continuous tracks 3A. By rotation of the continuous tracks 3A, the traveling body 3 performs travel operation. The travel operation of the traveling body 3 includes forward operation and backward operation. The hydraulic excavator 1 can move at the work site by the traveling body 3.

The revolving body 4 is supported by the traveling body 3. The revolving body 4 is disposed above the traveling body 3. The revolving body 4 performs revolving operation about an axis of revolution RX in a state of being supported by the traveling body 3. The axis of revolution RX is parallel to the Zm axis. The revolving operation of the revolving body 4 includes left revolving operation and right revolving operation. The cab 2 is provided at the revolving body 4.

The work implement 5 is attached to the revolving body 4. The work implement 5 performs work. In the embodiment, the work performed by the work implement 5 includes excavation work of excavating an object to be excavated 16 and soil removal work of removing an excavated object to an object to receive removed soil 17. The work performed by the work implement 5 includes loading work of moving the excavated object to the object to receive removed soil 17 after excavation work, and return work of moving toward the object to be excavated 16 after soil removal work.

The work implement 5 includes a boom 5A, an arm 5B, and a bucket 5C as a work tool. The base end portion of the boom 5A is operably coupled to a front portion of the revolving body 4. The base end portion of the arm 5B is operably coupled to a tip end portion of the boom 5A. The base end portion of the bucket 5C is operably coupled to a tip end portion of the arm 5B. Note that other examples of the work tool include a clamshell bucket, a tilt bucket, a tilt rotate bucket, and a grapple.

The hydraulic cylinder 6 operates the work implement 5. The hydraulic cylinder 6 includes a boom cylinder 6A, an arm cylinder 6B, and a bucket cylinder 6C. The boom cylinder 6A causes the boom 5A to perform raising operation and lowering operation. The arm cylinder 6B causes the arm 5B to perform excavation operation and dumping operation. The bucket cylinder 6C causes the bucket 5C to perform excavation operation and dumping operation. The base end portion of the boom cylinder 6A is coupled to the revolving body 4. The tip end portion of the boom cylinder 6A is coupled to the boom 5A. The base end portion of the arm cylinder 6B is coupled to the boom 5A. The tip end portion of the arm cylinder 6B is coupled to the arm 5B. The base end portion of the bucket cylinder 6C is coupled to the arm 5B. The tip end portion of the bucket cylinder 6C is coupled to the bucket 5C.

As illustrated in FIG. 3, the operation device 7 is disposed at the cab 2. The operation device 7 is operated to operate at least one of the traveling body 3, the revolving body 4, and the work implement 5. The operation device 7 is operated by an operator on board the cab 2. The operator can operate the operation device 7 in a state of being seated on an operator seat 15 disposed at the cab 2.

The operation device 7 includes a left operation lever 7A and a right operation lever 7B, a left travel lever 7C and a right travel lever 7D, and a left foot pedal 7E and a right foot pedal 7F.

The left operation lever 7A is operated to revolve the revolving body 4. The left operation lever 7A is operated to operate the work implement 5. The right operation lever 7B is operated to operate the work implement 5. With the left operation lever 7A being operated in the left-right direction, the revolving body 4 performs left revolving operation or right revolving operation. With the left operation lever 7A being operated in the front-rear direction, the arm 5B performs dumping operation or excavation operation. With the right operation lever 7B being operated in the left-right direction, the bucket 5C performs excavation operation or dumping operation. With the right operation lever 7B being operated in the front-rear direction, the boom 5A performs lowering operation or raising operation. Note that the revolving body 4 may perform right revolving operation or left revolving operation when the left operation lever 7A is operated in the front-rear direction, and the arm 5B may perform dumping operation or excavation operation when the left operation lever 7A is operated in the left-right direction. The revolving body 4 may perform left revolving operation or right revolving operation when the right operation lever 7B is operated in the left-right direction or the front-rear direction.

The left travel lever 7C and the right travel lever 7D are operated to operate the traveling body 3. With the left travel lever 7C being operated in the front-rear direction, the continuous track 3A on the left side of the traveling body 3 performs forward operation or backward operation. With the right travel lever 7D being operated in the front-rear direction, the continuous track 3A on the right side of the traveling body 3 performs forward operation or backward operation.

The left foot pedal 7E is interlocked with the left travel lever 7C. The right foot pedal 7F is interlocked with the right travel lever 7D. The traveling body 3 may perform forward operation or backward operation by the left foot pedal 7E and the right foot pedal 7F being operated.

The in-vehicle monitor 8 is disposed at the cab 2. The in-vehicle monitor 8 is disposed to the front right of the operator seat 15. The in-vehicle monitor 8 includes a display device 8A and an input device 8B. The display device 8A displays prescribed display data. Examples of the display device 8A include a flat panel display such as a liquid crystal display (LCD) or an organic electroluminescence display (OELD). The input device 8B generates input data by being operated by the operator. Examples of the input device 8B include a button switch, a computer keyboard, and a touch panel. Note that the display device 8A and the input device 8B may be separate bodies.

The input device 9 is disposed at the cab 2. The input device 9 is operated to generate a predetermined input signal. The input device 9 is operated by the operator on board the cab 2.

The operator can operate the input device 9 in a state of being seated on the operator seat 15 disposed at the cab 2.

The input device 9 includes a revolving lock switch 9A, an automatic permission switch 9B, a teaching switch 9C, and an automatic start switch 9D. Each of the revolving lock switch 9A and the automatic permission switch 9B is disposed to the right of the operator seat 15. Each of the teaching switch 9C and the automatic start switch 9D is disposed at the left operation lever 7A.

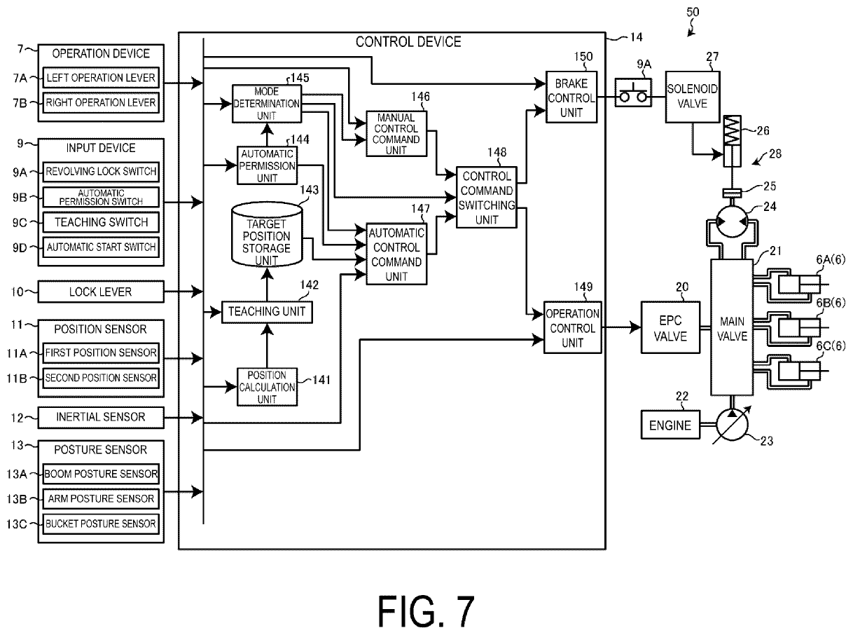

The hydraulic excavator 1 includes a revolving parking brake 28 (see FIG. 7) that can stop revolving of the revolving body 4 by mechanical braking force. The revolving parking brake 28 is a hydraulic negative brake. Actuation of the revolving parking brake 28 is released by introducing pressure oil from a solenoid valve 27. The revolving lock switch 9A is operated by the operator to bring the revolving parking brake 28 into an actuation state or a release state. The control device 14 receives one or both of an input signal indicating that the revolving lock switch 9A is operated to bring the revolving parking brake 28 into the actuation state and an input signal indicating that the revolving lock switch 9A is operated to bring the revolving parking brake 28 into the release state.

For example, once the revolving lock switch 9A is operated by the operator to bring the revolving parking brake 28 into the actuation state, the revolving parking brake 28 is activated and the revolving of the revolving body 4 is stopped. When the revolving parking brake 28 is being activated, the revolving body 4 does not revolve even if the left operation lever 7A is operated so that the revolving body 4 performs revolving operation. For example, when the work implement 5 is operated in a state where the revolving body 4 is not revolved in a manual mode, the operator operates the revolving lock switch 9A. When the revolving body 4 is not revolved, it is highly likely that the left operation lever 7A for revolving the revolving body 4 is brought into the neutral state. When the hydraulic excavator 1 works on, for example, an inclined surface, if the left operation lever 7A is in the neutral state, it is likely that the revolving body 4 revolves due to the own weight of the revolving body 4. When the revolving parking brake 28 is activated by the operation of the revolving lock switch 9A, the revolving body 4 is suppressed from revolving operation even if the left operation lever 7A is in the neutral state.

Note that the left operation lever 7A for revolving the revolving body 4 being in the neutral state means that the left operation lever 7A is in the neutral state at least in a predetermined direction when the revolving body 4 performs revolving operation with the left operation lever 7A being operated in the predetermined direction. For example, when the revolving body 4 performs revolving operation with the left operation lever 7A being operated in the left-right direction, the left operation lever 7A being in the neutral state means that the left operation lever 7A is in the neutral state at least in the left-right direction. When the revolving body 4 performs revolving operation with the left operation lever 7A being operated in the front-rear direction, the left operation lever 7A being in the neutral state means that the left operation lever 7A is in the neutral state at least in the front-rear direction.

The automatic permission switch 9B is operated to permit automatic control of the revolving body 4 and the work implement 5. The teaching switch 9C is operated to set a target position of the bucket 5C in automatic control. The target position of the bucket 5C includes an excavation target position 16R, a soil removal target position 17R, and an intermediate target position 18R described later. The automatic start switch 9D is operated to start automatic control.

The lock lever 10 is operated to disable each of the revolving body 4 and the work implement 5. The lock lever 10 is provided at the cab 2. The lock lever 10 is disposed at a boarding passage connecting an entrance provided at the cab 2 and the operator seat 15. The lock lever 10 is rotatably supported on a floor surface of the cab 2. The lock lever 10 is operated to move between a lock position and a free position. The control device 14 receives one or both of an operation signal indicating that the lock lever 10 is operated to the lock position and an operation signal indicating that the lock lever 10 is operated to the free position.

When the lock lever 10 is operated to the lock position, a flow path of a hydraulic circuit including a hydraulic pump is blocked, and each of the revolving body 4 and the work implement 5 is brought into a locked state of being disabled. When the lock lever 10 is operated to the lock position, the boarding passage is opened. With the boarding passage being opened, the operator can pass through the boarding passage. When the lock lever 10 is operated to the free position, the flow path of the hydraulic circuit including the hydraulic pump is in communication, and each of the revolving body 4 and the work implement 5 is brought into a free state of being freely operable by the operation device 7. When the lock lever 10 is operated to the free position, the boarding passage is closed. With the boarding passage being closed, it becomes difficult for the operator to pass through the boarding passage.

The operator present outside the cab 2 can be seated on the operator seat 15 after passing through the opened boarding passage. After being seated on the operator seat 15, the operator operates the lock lever 10 to the free position. With the lock lever 10 being operated to the free position, each of the revolving body 4 and the work implement 5 is brought into the free state. The operator can perform work by operating the operation device 7.

When leaving the cab 2, the operator seated on the operator seat 15 operates the lock lever 10 to the lock position to open the boarding passage. The operator can leave the cab 2 by passing through the opened boarding passage. With the lock lever 10 being operated to the lock position, each of the revolving body 4 and the work implement 5 is brought into the locked state. Since each of the revolving body 4 and the work implement 5 is brought into the locked state, the revolving body 4 and the work implement 5 are suppressed from moving when the operator is not present in the cab 2.

The position sensor 11 detects a position in the site coordinate system. The position sensor 11 detects the position in the site coordinate system using a global navigation satellite system (GNSS). The global navigation satellite system includes a global positioning system (GPS). The global navigation satellite system detects the position defined by coordinate data of latitude, longitude, and altitude. The position sensor 11 includes a GNSS receiver that receives GNSS radio waves from a GNSS satellite. The position sensor 11 is disposed at the revolving body 4.

The position sensor 11 includes a first position sensor 11A and a second position sensor 11B. The first position sensor 11A and the second position sensor 11B are disposed at different positions of the revolving body 4. In the embodiment, the first position sensor 11A and the second position sensor 11B are disposed at intervals in the left-right direction at the revolving body 4. The first position sensor 11A detects a first measurement position indicating the position where the first position sensor 11A is disposed. The second position sensor 11B detects a second measurement position indicating the position where the second position sensor 11B is disposed. An orientation of the revolving body 4 is calculated based on detection data of the first position sensor 11A and detection data of the second position sensor 11B.

The inertial sensor 12 detects acceleration and angular velocity of the revolving body 4. The inertial sensor 12 includes an inertial measurement unit (IMU). The inertial sensor 12 is disposed at the revolving body 4. The inertial sensor 12 can detect the revolving speed of the revolving body 4.

The posture sensor 13 detects the posture of the work implement 5. The posture of the work implement 5 includes the angle of the work implement 5. The posture sensor 13 is provided at the work implement 5. The posture sensor 13 includes a boom posture sensor 13A that detects the posture of the boom 5A, an arm posture sensor 13B that detects the posture of the arm 5B, and a bucket posture sensor 13C that detects the posture of the bucket 5C. The boom posture sensor 13A detects an angle of the boom 5A with respect to the axis of revolution RX, for example. The arm posture sensor 13B detects an angle of the arm 5B with respect to the boom 5A. The bucket posture sensor 13C detects an angle of the bucket 5C with respect to the arm 5B. Examples of the posture sensor 13 include a potentiometer. Note that the posture sensor 13 may be a stroke sensor that detects a stroke of the hydraulic cylinder 6 (the boom cylinder 6A, the arm cylinder 6B, and the bucket cylinder 6C). When the IMU is attached to each of the boom 5A, the arm 5B, and the bucket 5C, each IMU may detect the angle of the corresponding one of the boom 5A, the arm 5B, and the bucket 5C.

### Operation of Work Machine

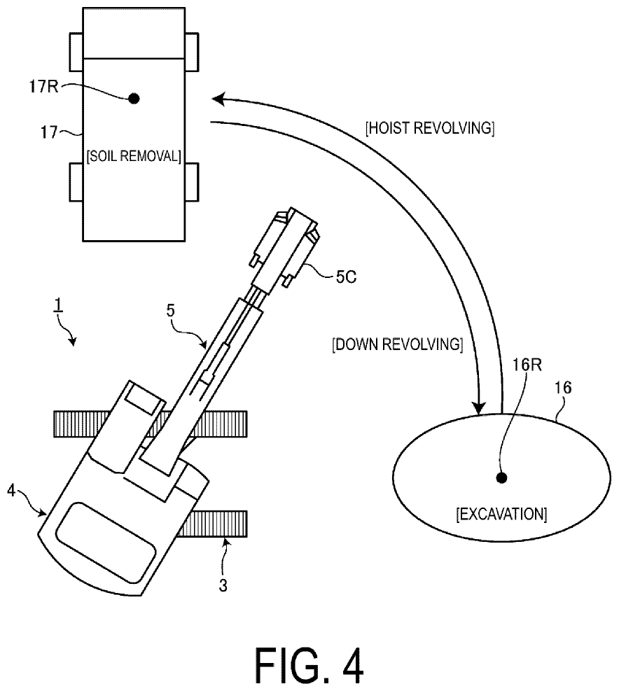

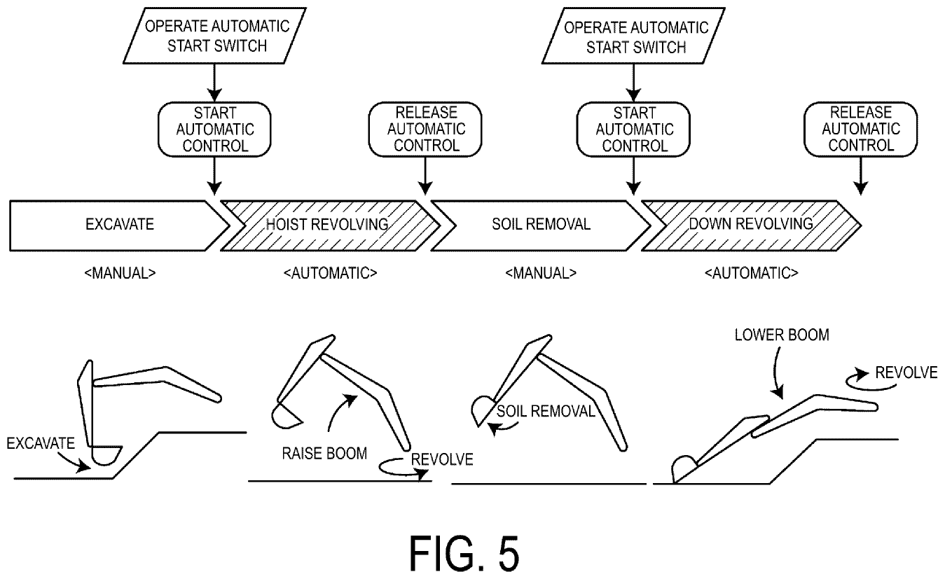

Each of FIGS. 4 and 5 is a diagram for describing the operation of the hydraulic excavator 1 according to the embodiment. In the embodiment, the hydraulic excavator 1 repeats an excavation operation, a hoist revolving operation, a soil removal operation, and a down revolving operation. The excavation operation refers to an operation of excavating the object to be excavated 16 with the bucket 5C in a state where the front surface of the revolving body 4 faces the object to be excavated 16. The hoist revolving operation refers to an operation of performing both operations of an operation of raising the work implement 5 and an operation of revolving the revolving body 4. The hoist revolving operation includes an operation of performing both operations of raising operation of the boom 5A and a revolving operation of the revolving body 4. For example, the hoist revolving operation refers to an operation of operating the work implement 5 and revolving the revolving body 4 such that after the object to be excavated 16 is excavated with the bucket 5C, the front surface of the revolving body 4 faces the object to receive removed soil 17, and the bucket 5C holding the excavated object is placed above the object to receive removed soil 17. The soil removal operation refers to an operation of removing the excavated object held by the bucket 5C to the object to receive removed soil 17 in a state where the front surface of the revolving body 4 faces the object to receive removed soil 17. The down revolving operation refers to an operation of performing both operations of an operation of lowering the work implement 5 and an operation of revolving the revolving body 4. The down revolving operation includes an operation of performing both operations of a lowering operation of the boom 5A and a revolving operation of the revolving body 4. For example, the down revolving operation refers to an operation of operating the work implement 5 and revolving the revolving body 4 such that after the excavated object is removed from the bucket 5C to the object to receive removed soil 17, the front surface of the revolving body 4 faces the object to be excavated 16, and the bucket 5C is placed at the object to be excavated 16. Examples of the object to receive removed soil 17 include a bed of a dump truck. Note that other examples of the object to receive removed soil 17 include a hopper, a self-propelled soil improver, and a belt conveyor.

The hoist revolving operation and the down revolving operation are examples of combined operation including the operation of the work implement 5 and the operation of the revolving body 4. The operation of the work implement 5 in the combined operation includes the operation of the boom 5A. The operation of the boom 5A in the combined operation includes the raising operation of the boom 5A or the lowering operation of the boom 5A. When the revolving body 4 revolves left in the hoist revolving operation, the revolving body 4 revolves right in the down revolving operation. When the revolving body 4 revolves right in the hoist revolving operation, the revolving body 4 revolves left in the down revolving operation. That is, the revolving direction of the revolving body 4 in the hoist revolving operation and the revolving direction of the revolving body 4 in the down revolving operation are different. Note that the revolving direction of the revolving body 4 in the hoist revolving operation and the revolving direction of the revolving body 4 in the down revolving operation may be the same.

The operation mode of the revolving body 4 and the work implement 5 includes a manual mode and an automatic mode. The operation mode of the revolving body 4 and the work implement 5 is switched between the manual mode and the automatic mode. The manual mode refers to an operation mode in which each of the revolving body 4 and the work implement 5 operates based on the operation of the operation device 7 by the operator. That is, the manual mode is an operation mode in which each of the revolving body 4 and the work implement 5 is manually operated. The automatic mode refers to an operation mode in which each of the revolving body 4 and the work implement 5 operates not based on the operation of the operation device 7 but based on an automatic control command output from the control device 14. That is, the automatic mode is an operation mode in which each of the revolving body 4 and the work implement 5 is automatically controlled. The automatic control command is a command not based on the operation of the operation device 7. Note that the automatic mode may be an operation mode in which either the revolving body 4 or the work implement 5 operates based on an automatic control command output from the control device 14.

The operation mode of the excavation operation, which is an example of excavation work, is the manual mode. In excavation operation, each of the revolving body 4 and the work implement 5 is manually operated.

The operation mode of the hoist revolving operation, which is an example of loading work, is the automatic mode. In the hoist revolving operation, each of the revolving body 4 and the work implement 5 is automatically controlled. After the excavation operation ends, with the automatic start switch 9D being operated, the operation mode transitions from the manual mode to the automatic mode. Once the excavation operation ends and the automatic start switch 9D is operated, automatic control of the revolving body 4 and the work implement 5 is started. In the hoist revolving operation, the revolving body 4 automatically revolves and the work implement 5 automatically operates so that the bucket 5C is placed at the soil removal target position 17R set at the object to receive removed soil 17. In the hoist revolving operation, the raising operation of the boom 5A is performed such that the excavated object held by the bucket 5C does not spill from the bucket 5C. When the bucket 5C reaches the soil removal target position 17R, the operation mode transitions from the automatic mode to the manual mode. That is, when the bucket 5C reaches the soil removal target position 17R, the automatic control of the revolving body 4 and the work implement 5 is released. Note that in the hoist revolving operation, the automatic control of the revolving body 4 and the work implement 5 may be released also with the operation device 7 being operated by the operator.

The operation mode of the soil removal operation, which is an example of soil removal work, is the manual mode. In soil removal operation, each of the revolving body 4 and the work implement 5 is manually operated. After the bucket 5C reaches the soil removal target position 17R and the automatic control of the revolving body 4 and the work implement 5 is released, the operator can perform the soil removal operation by the work implement 5 including the bucket 5C by operating the operation device 7.

The operation mode of the down revolving operation, which is an example of return work, is the automatic mode. In the down revolving operation, each of the revolving body 4 and the work implement 5 is automatically controlled. After the soil removal operation ends, with the automatic start switch 9D being operated, the operation mode transitions from the manual mode to the automatic mode. Once the soil removal operation ends and the automatic start switch 9D is operated, automatic control of the revolving body 4 and the work implement 5 is started. In the down revolving operation, the revolving body 4 automatically revolves and the work implement 5 automatically operates so that the bucket 5C is placed at the excavation target position 16R set at the object to be excavated 16. In the down revolving operation, the lowering operation of the boom 5A is performed. When the bucket 5C reaches the excavation target position 16R, the operation mode transitions from the automatic mode to the manual mode. That is, when the bucket 5C reaches the excavation target position 16R, the automatic control of the revolving body 4 and the work implement 5 is released. Note that in the down revolving operation, the automatic control of the revolving body 4 and the work implement 5 is also released with the operation device 7 being operated by the operator.

After the bucket 5C reaches the excavation target position 16R and the automatic control of the revolving body 4 and the work implement 5 is released, the operator can perform the excavation operation by operating the operation device 7.

### Teaching Process

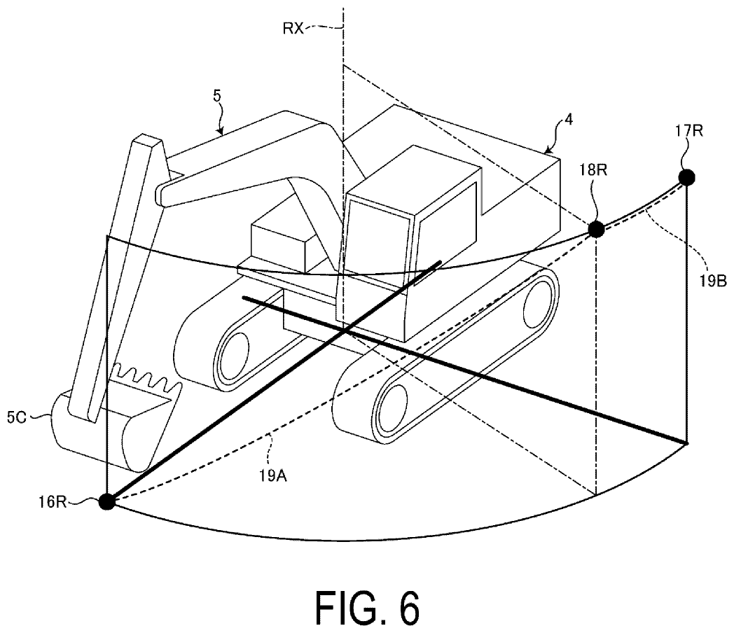

FIG. 6 is a view for describing a teaching process of setting the excavation target position 16R and the soil removal target position 17R according to the embodiment. The excavation target position 16R and the soil removal target position 17R are set by the teaching process.

When setting the excavation target position 16R, the operator operates the operation device 7 to place the bucket 5C at any position of the object to be excavated 16, and then operates the teaching switch 9C. The control device 14 stores, as the excavation target position 16R, the position of the bucket 5C at the time point when the teaching switch 9C is operated.

The position of the bucket 5C is defined based on the orientation of the revolving body 4 and the posture of the work implement 5. In the embodiment, the control device 14 stores, as position data related to the excavation target position 16R, the orientation of the revolving body 4 and the posture of the work implement 5 at the time point when the teaching switch 9C is operated. The orientation of the revolving body 4 is calculated based on the detection data of the first position sensor 11A and the detection data of the second position sensor 11B. The posture of the work implement 5 is detected by the posture sensor 13. The control device 14 stores, as position data related to the excavation target position 16R, the detection data of the position sensor 11 (11A and 11B) and the detection data of the posture sensor 13 (13A, 13B, and 13C) at the time point when the teaching switch 9C is operated.

When setting the soil removal target position 17R, the operator operates the operation device 7 to place the bucket 5C at a position above the object to receive removed soil 17, and then operates the teaching switch 9C. The control device 14 stores, as the soil removal target position 17R, the position of the bucket 5C at the time point when the teaching switch 9C is operated. The control device 14 stores, as position data related to the soil removal target position 17R, the orientation of the revolving body 4 and the posture of the work implement 5 at the time point when the teaching switch 9C is operated. The control device 14 stores, as position data related to the soil removal target position 17R, the detection data of the position sensor 11 (11A and 11B) and the detection data of the posture sensor 13 (13A, 13B, and 13C) at the time point when the teaching switch 9C is operated.

In the embodiment, the intermediate target position 18R is set in addition to the excavation target position 16R and the soil removal target position 17R. The intermediate target position 18R is set between the excavation target position 16R and the soil removal target position 17R. The intermediate target position 18R is set at a position away from the object to receive removed soil 17. The intermediate target position 18R is set at a position where the bucket 5C is not in contact with the object to receive removed soil 17. When setting the intermediate target position 18R, the operator operates the operation device 7 to place the bucket 5C at a position not in contact with the object to receive removed soil 17 between the excavation target position 16R and the soil removal target position 17R, and then operates the teaching switch 9C. The control device 14 stores, as the intermediate target position 18R, the position of the bucket 5C at the time point when the teaching switch 9C is operated. The control device 14 stores, as position data related to the intermediate target position 18R, the orientation of the revolving body 4 and the posture of the work implement 5 at the time point when the teaching switch 9C is operated. The control device 14 stores, as position data related to the intermediate target position 18R, the detection data of the position sensor 11 (11A and 11B) and the detection data of the posture sensor 13 (13A, 13B, and 13C) at the time point when the teaching switch 9C is operated.

After each of the excavation target position 16R, the intermediate target position 18R, and the soil removal target position 17R is set, the control device 14 sets a first route 19A connecting the excavation target position 16R and the intermediate target position 18R and a second route 19B connecting the intermediate target position 18R and the soil removal target position 17R. The control device 14 controls the posture of the work implement 5 such that the bucket 5C passes through the first route 19A and the second route 19B in revolving of the revolving body 4. In the embodiment, the control device 14 controls the hydraulic cylinder 6 so that the work implement 5 operates at the first route 19A and the work implement 5 does not operate at the second route 19B.

### Control System

FIG. 7 is a block diagram illustrating a control system 50 of the work machine 1 according to the embodiment. The hydraulic excavator 1 includes the control system 50. The control system 50 includes the operation device 7, the input device 9, the lock lever 10, the position sensor 11, the inertial sensor 12, the posture sensor 13, and the control device 14. The control device 14 controls the hydraulic excavator 1. The control device 14 includes a computer system. Each of the operation device 7, the input device 9, the lock lever 10, the position sensor 11, the inertial sensor 12, and the posture sensor 13 is connected to the control device 14.

The operation device 7 including the left operation lever 7A and the right operation lever 7B generates an operation signal by being operated by the operator. The operation signal generated by the operation device 7 is input to the control device 14.

The input device 9 including the revolving lock switch 9A, the automatic permission switch 9B, the teaching switch 9C, and the automatic start switch 9D generates an input signal by being operated by the operator. The input signal generated by the input device 9 is input to the control device 14. The revolving lock switch 9A is disposed between the control device 14 and the solenoid valve 27. As described above, the control device 14 receives one or both of the input signal indicating that the revolving lock switch 9A is operated to bring the revolving parking brake 28 into the actuation state and the input signal indicating that the revolving lock switch 9A is operated to bring the revolving parking brake 28 into the release state.

The lock lever 10 generates an operation signal by being operated by the operator. The operation signal generated by the lock lever 10 is input to the control device 14. As described above, the control device 14 receives one or both of the operation signal indicating that the lock lever 10 is operated to the lock position and the operation signal indicating that the lock lever 10 is operated to the free position.

The detection data of the position sensor 11 including the first position sensor 11A and the second position sensor 11B is input to the control device 14. The detection data of the inertial sensor 12 is input to the control device 14. The detection data of the posture sensor 13 including the boom posture sensor 13A, the arm posture sensor 13B, and the bucket posture sensor 13C is input to the control device 14.

The control system 50 includes an EPC valve 20, a main valve 21, an engine 22, a hydraulic pump 23, the hydraulic cylinder 6, a revolving motor 24, and the revolving parking brake 28.

The revolving motor 24 is a hydraulic motor. The revolving motor 24 generates power for revolving the revolving body 4. The hydraulic cylinder 6 including the boom cylinder 6A, the arm cylinder 6B, and the bucket cylinder 6C generates power for operating the work implement 5. The engine 22 is a power source of the hydraulic excavator 1. The hydraulic pump 23 is driven by the engine 22. The hydraulic pump 23 discharges hydraulic oil for activating each of the hydraulic cylinder 6 and the revolving motor 24. The main valve 21 is connected to the hydraulic pump 23. The hydraulic pump 23 supplies hydraulic oil to each of the hydraulic cylinder 6 and the revolving motor 24 via the main valve 21. The main valve 21 includes a spool. With the spool of the main valve 21 moving, the direction and flow rate of the hydraulic oil supplied from the hydraulic pump 23 to the hydraulic cylinder 6 are adjusted. The main valve 21 can extend or contract the boom cylinder 6A by adjusting the direction of the hydraulic oil supplied to the boom cylinder 6A, for example. The main valve 21 can adjust the activation speed of the boom cylinder 6A by adjusting the flow rate of the hydraulic oil supplied to the boom cylinder 6A. The same applies to the arm cylinder 6B and the bucket cylinder 6C. With the spool of the main valve 21 moving, the direction and flow rate of the hydraulic oil supplied from the hydraulic pump 23 to the revolving motor 24 are adjusted. The main valve 21 can adjust the rotation direction of the revolving motor 24 so that the revolving body 4 performs a left revolving operation or a right revolving operation by adjusting the direction of the hydraulic oil supplied to the revolving motor 24. The main valve 21 can adjust the rotation speed of the revolving motor 24 by adjusting the flow rate of the hydraulic oil supplied to the revolving motor 24. The EPC valve 20 applies, to the main valve 21, pilot pressure for moving the spool of the main valve 21. The EPC valve 20 adjusts the pilot pressure based on a control command (drive signal) from the control device 14.

The revolving parking brake 28 can stop revolving of the revolving body 4. In actuation of the revolving parking brake 28, mechanical braking force of the revolving parking brake 28 is generated, and revolving of the revolving body 4 is stopped. In actuation of the revolving parking brake 28, mechanical braking force of the revolving parking brake 28 is released, and the revolving body 4 can revolve. The revolving parking brake 28 includes a negative disc brake. The revolving parking brake 28 includes a pair of brake discs 25, a brake cylinder 26, and the solenoid valve 27. When the solenoid valve 27 is driven and the brake cylinder 26 is contracted, the pair of brake discs 25 are separated from each other, and activation of the revolving parking brake 28 is released. Once the drive of the solenoid valve 27 is stopped, the brake cylinder 26 extends by elastic force of a spring provided at the brake cylinder 26. When the brake cylinder 26 extends, the pair of brake discs 25 come into contact with each other, and the revolving parking brake 28 is activated.

The control device 14 includes a position calculation unit 141, a teaching unit 142, a target position storage unit 143, an automatic permission unit 144, a mode determination unit 145, a manual control command unit 146, an automatic control command unit 147, a control command switching unit 148, an operation control unit 149, and a brake control unit 150.

The position calculation unit 141 calculates the position of the bucket 5C based on the detection data of the position sensor 11 and the detection data of the posture sensor 13. The position calculation unit 141 calculates the orientation of the revolving body 4 based on the detection data of the first position sensor 11A and the detection data of the second position sensor 11B. The position calculation unit 141 calculates the position of the bucket 5C with respect to the revolving body 4 based on the detection data of the posture sensor 13 and dimensional data of the work implement 5. The dimensional data of the work implement 5 includes the length of the boom 5A, the length of the arm 5B, and the length of the bucket 5C. The dimensional data of the work implement 5 is known data. The position calculation unit 141 can calculate the position of the bucket 5C in, for example, the vehicle body coordinate system based on the orientation of the revolving body 4 and the position of the bucket 5C with respect to the revolving body 4.

The teaching unit 142 calculates each position of the excavation target position 16R, the soil removal target position 17R, and the intermediate target position 18R based on the position of the bucket 5C at the time point when an input signal from the teaching switch 9C is received. As described with reference to FIG. 6, in the teaching process, each of the excavation target position 16R, the soil removal target position 17R, and the intermediate target position 18R is set. When the excavation target position 16R is set, the teaching switch 9C is operated after the bucket 5C is placed at an arbitrary position of the object to be excavated 16 by the operation of the operation device 7. The teaching unit 142 calculates, as the excavation target position 16R, the position of the bucket 5C at the time point when the input signal from the teaching switch 9C is received. When the soil removal target position 17R is set, the teaching switch 9C is operated after the bucket 5C is placed at a position above the object to receive removed soil 17 by the operation of the operation device 7. The teaching unit 142 calculates, as the soil removal target position 17R, the position of the bucket 5C at the time point when the input signal from the teaching switch 9C is received. When the intermediate target position 18R is set, the teaching switch 9C is operated after the bucket 5C is placed at a position not in contact with the object to receive removed soil 17 by the operation of the operation device 7. The teaching unit 142 calculates, as the intermediate target position 18R, the position of the bucket 5C at the time point when the input signal from the teaching switch 9C is received. The teaching unit 142 sets the excavation target position 16R at the object to be excavated 16, sets the soil removal target position 17R at the object to receive removed soil 17, and sets the intermediate target position 18R between the excavation target position 16R and the soil removal target position 17R. The teaching unit 142 sets the first route 19A and the second route 19B.

Note that when each of the excavation target position 16R, the soil removal target position 17R, and the intermediate target position 18R is set, guidance prompting setting may be output to the cab 2. The operator may set each of the excavation target position 16R, the soil removal target position 17R, and the intermediate target position 18R by operating the input device 8B based on the guidance. The guidance prompting setting may be displayed on the display device 8A. When a sound output device that outputs sound is disposed at the cab 2, guidance prompting setting may be output from the sound output device.

The target position storage unit 143 stores each of the excavation target position 16R set at the object to be excavated 16, the soil removal target position 17R set at the object to receive removed soil 17, and the intermediate target position 18R set between the excavation target position 16R and the soil removal target position 17R. The target position storage unit 143 stores the first route 19A and the second route 19B.

The automatic permission unit 144 determines whether automatic control of the revolving body 4 and the work implement 5 is possible based on the operation state of the revolving lock switch 9A. The automatic permission unit 144 prohibits automatic control when the revolving lock switch 9A is in a state of being operated. That is, when the revolving lock switch 9A is in an ON state and the revolving parking brake 28 is in the actuation state, the automatic permission unit 144 prohibits the automatic control based on the input signal from the revolving lock switch 9A. The automatic permission unit 144 permits automatic control when the revolving lock switch 9A is in a state of being not operated. That is, when the revolving lock switch 9A is in an OFF state and the revolving parking brake 28 is in the release state, the automatic permission unit 144 permits the automatic control.

The mode determination unit 145 determines the operation mode of the revolving body 4 and the work implement 5 based on a predetermined transition condition.

The manual control command unit 146 generates a manual control command for operating at least one of the revolving body 4 and the work implement 5 based on an operation signal from at least one of the left operation lever 7A and the right operation lever 7B. In the manual mode, the manual control command unit 146 outputs the manual control command to the control command switching unit 148.

The automatic control command unit 147 generates an automatic control command for automatically controlling the revolving body 4 and the work implement 5. In the automatic mode, the automatic control command unit 147 outputs the automatic control command to the control command switching unit 148.

A manual control command from the manual control command unit 146 and an automatic control command from the automatic control command unit 147 are input to the control command switching unit 148. The control command switching unit 148 outputs one of the manual control command and the automatic control command to the brake control unit 150. The control command switching unit 148 outputs one of the manual control command and the automatic control command to the operation control unit 149. In the manual mode, the manual control command is output from the control command switching unit 148. In the automatic mode, the automatic control command is output from the control command switching unit 148.

The brake control unit 150 controls the revolving parking brake 28. The brake control unit 150 controls the revolving parking brake 28 based on the operation state of the left operation lever 7A operated to revolve the revolving body 4 or the output state of the automatic control command from the automatic control command unit 147. Note that the brake control unit 150 may control the revolving parking brake 28 based on the operation state of the operation device 7 operated to operate the work implement 5. For example, when the operation lever (7A and 7B) for operating the work implement 5 is operated, the brake control unit 150 releases actuation of the revolving parking brake 28. For example, the brake control unit 150 may release actuation of the revolving parking brake 28 when an operation pedal 7G, which is an example of the operation device 7 for operating a tilt rotator, a hydraulic breaker, and the like, is operated.

When the revolving lock switch 9A is operated in the manual mode in which the automatic control command is not output, the brake control unit 150 activates the revolving parking brake 28 based on the input signal from the revolving lock switch 9A.

The brake control unit 150 actuates the revolving parking brake 28 when the operation state of the left operation lever 7A operated to revolve the revolving body 4 satisfies a predetermined brake activation condition in the manual mode in which the automatic control command is not output. In the manual mode, the manual control command unit 146 outputs, to the control command switching unit 148, a manual control command indicating that the operation state of the left operation lever 7A satisfies the brake activation condition based on the operation signal from the left operation lever 7A. In the manual mode, the control command switching unit 148 outputs, to the brake control unit 150, a manual control command indicating that the operation state of the left operation lever 7A satisfies the brake activation condition. The brake activation condition includes that the left operation lever 7A operated to revolve the revolving body 4 is in the neutral state for a predetermined time set in advance. The neutral state of the left operation lever 7A refers to a state in which an operation signal for revolving the revolving body 4 is not output from the left operation lever 7A. Note that the neutral state of the left operation lever 7A may be a state in which an operation signal for preventing the revolving body 4 from revolving is output from the left operation lever 7A. When the revolving body 4 revolves by the left operation lever 7A being operated in the left-right direction, the neutral state of the left operation lever 7A refers to a state in which the left operation lever 7A is placed at a center position in the left-right direction. In the embodiment, the predetermined time is, for example, 5 seconds. In the manual mode, when the left operation lever 7A has been in the neutral state for 5 seconds, the brake control unit 150 activates the revolving parking brake 28.

In the automatic mode in which the automatic control command is output, the brake control unit 150 controls the revolving parking brake 28 not based on the operation state of the left operation lever 7A but based on the automatic control command output from the automatic control command unit 147. In the automatic mode, the control command switching unit 148 outputs, to the brake control unit 150, the automatic control command from the automatic control command unit 147. In the automatic mode, it is highly likely that the operator does not move each of the left operation lever 7A and the right operation lever 7B or releases the hand from each of the left operation lever 7A and the right operation lever 7B. That is, in the automatic mode, it is highly likely that the left operation lever 7A is maintained in the neutral state. In the automatic mode, when the left operation lever 7A has been in the neutral state for 5 seconds, the revolving parking brake 28 is actuated. In the embodiment, the revolving parking brake 28 is actuated when the left operation lever 7A has been in the neutral state for 5 seconds in the manual mode, but the revolving parking brake 28 is not actuated even when the left operation lever 7A has been in the neutral state for 5 seconds in the automatic mode. The brake control unit 150 releases actuation of the revolving parking brake 28 in the automatic control of the revolving body 4.

In the automatic mode, the brake control unit 150 actuates the revolving parking brake 28 when the output state of the automatic control command output from the automatic control command unit 147 satisfies a predetermined brake activation condition. For example, in the automatic mode, when the operation signal from the operation device 7 for operating the work implement 5 and the revolving body 4 is a neutral command signal, the actuation of the revolving parking brake 28 is not released. For example, in a dump standby mode, the neutral command signal is output.

The operation control unit 149 controls the revolving body 4 and the work implement 5. In the manual mode, the manual control command unit 146 generates a manual control command based on the operation signal from at least one of the left operation lever 7A and the right operation lever 7B. The control command switching unit 148 outputs, to the operation control unit 149, the manual control command generated by the manual control command unit 146. In the automatic mode, the automatic control command unit 147 generates an automatic control command. The control command switching unit 148 outputs, to the operation control unit 149, the automatic control command generated by the automatic control command unit 147. In the manual mode, the operation control unit 149 outputs a drive signal for controlling the revolving body 4 based on the manual control command supplied from the control command switching unit 148. In the automatic mode, the operation control unit 149 outputs a drive signal for controlling the revolving body 4 based on the automatic control command supplied from the control command switching unit 148. The drive signal for controlling the revolving body 4 includes a drive signal for driving the EPC valve 20. In the manual mode, the operation control unit 149 outputs a drive signal for driving the EPC valve 20 based on the manual control command supplied from the control command switching unit 148. In the automatic mode, the operation control unit 149 outputs a drive signal for driving the EPC valve 20 based on the automatic control command supplied from the control command switching unit 148. The operation control unit 149 supplies the EPC valve 20 with an EPC current for driving the EPC valve 20. The EPC valve 20 applies pilot pressure to the spool of the main valve 21 based on the EPC current supplied from the operation control unit 149.

When the lock lever 10 is operated to the lock position, the operation control unit 149 cuts source pressure to the EPC valve 20 based on the operation signal from the lock lever 10, and blocks, with the control valve, the oil discharged from the hydraulic pump. When the source pressure is cut, the main valve 21 is disabled. By the main valve 21 being disabled, each of the revolving body 4 and the work implement 5 is brought into a locked state of being disabled. Note that the drive of the control valve may be controlled by another control device or the like.

### Determination Whether Automatic Control is Possible

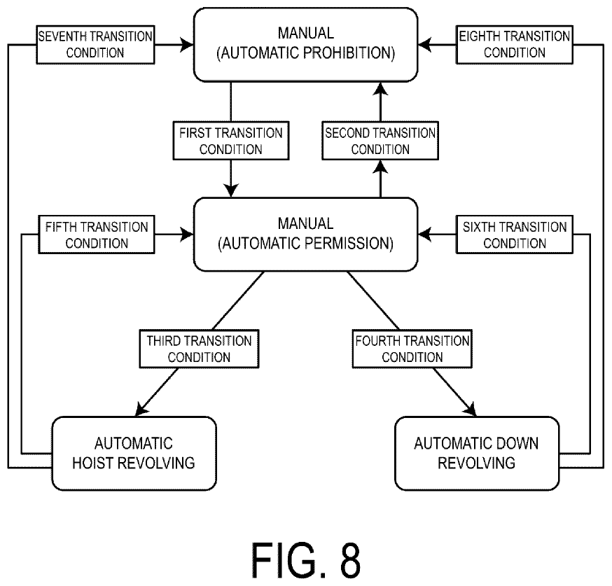

FIG. 8 is a diagram for describing determination as to whether automatic control is possible and switching of the operation mode according to the embodiment. When a first transition condition is not satisfied in a state where automatic control is prohibited in the manual mode, the automatic control is prohibited. When the first transition condition is satisfied in a state where the automatic control is prohibited in the manual mode, the automatic control is permitted. The first transition condition includes that the revolving lock switch 9A has not been operated. The automatic permission unit 144 prohibits the automatic control when the revolving parking brake 28 is activated by operation of the revolving lock switch 9A in the manual mode. In the manual mode, the automatic permission unit 144 permits the automatic control when the revolving parking brake 28 is not activated by non-operation of the revolving lock switch 9A.

Note that the first transition condition may include that the revolving lock switch 9A has not been operated and that the lock lever 10 is operated to the free position. That is, the automatic permission unit 144 may determine whether automatic control is possible based on the operation state of the revolving lock switch 9A and the operation state of the lock lever 10. For example, in the manual mode, the automatic permission unit 144 prohibits the automatic control when the revolving parking brake 28 is activated by operation of the revolving lock switch 9A and the revolving body 4 and the work implement 5 are in the locked state by the movement of the lock lever 10 to the lock position. In the manual mode, the automatic permission unit 144 permits the automatic control when the revolving parking brake 28 is not activated by non-operation of the revolving lock switch 9A and the revolving body 4 and the work implement 5 are in the free state by the movement of the lock lever 10 to the free position.

Note that the first transition condition may include that the revolving lock switch 9A has not been operated, that the lock lever 10 is operated to the free position, that the automatic permission switch 9B is operated, that the GNSS is available, and that the target position (the excavation target position 16R, the soil removal target position 17R, and the intermediate target position 18R) in the automatic control is already set. At least one of that the revolving lock switch 9A has not been operated, that the lock lever 10 is operated to the free position, that the automatic permission switch 9B is operated, that the GNSS is available, and that the target position (the excavation target position 16R, the soil removal target position 17R, and the intermediate target position 18R) in the automatic control is already set may be the first transition condition.

When a second transition condition is satisfied in a state where the automatic control is permitted in the manual mode, the automatic control is prohibited. The second transition condition includes that the revolving lock switch 9A is operated. The second transition condition may be that the revolving lock switch 9A is operated or that the lock lever 10 is operated to the lock position. The second transition condition may include at least one of that the revolving lock switch 9A is operated, that the lock lever 10 is operated to the lock position, that the automatic permission switch 9B has not been operated, that the GNSS is unavailable, and that the target position (the excavation target position 16R, the soil removal target position 17R, and the intermediate target position 18R) in the automatic control has not been set. For example, it is likely that the GNSS becomes unavailable due to ionospheric scintillation or the like.

The automatic control command unit 147 outputs an automatic control command when the automatic start switch 9D is operated in a state where automatic control is permitted in the manual mode. That is, when the automatic start switch 9D is operated in a state where the automatic control is permitted in the manual mode, the operation mode transitions from the manual mode to the automatic mode.

When a third transition condition is satisfied in a state where the automatic control is permitted in the manual mode, the hoist revolving operation is started in the automatic mode. The third transition condition includes that the automatic start switch 9D is operated when the bucket 5C is placed in the vicinity of the object to be excavated 16. Once the automatic start switch 9D is operated, the automatic control command unit 147 outputs an automatic control command such that the bucket 5C of the work implement 5 moves to the soil removal target position 17R based on the input signal from the automatic start switch 9D.

When a fourth transition condition is satisfied in a state where the automatic control is permitted in the manual mode, the down revolving operation is started in the automatic mode. The fourth transition condition includes that the automatic start switch 9D is operated when the bucket 5C is placed in the vicinity of the object to receive removed soil 17. Once the automatic start switch 9D is operated, the automatic control command unit 147 outputs an automatic control command such that the bucket 5C of the work implement 5 moves to the excavation target position 16R based on the input signal from the automatic start switch 9D.

When a fifth transition condition is satisfied in a state where the hoist revolving operation is being performed in the automatic mode, the operation mode transitions from the automatic mode to the manual mode in which automatic control is permitted. The fifth transition condition includes at least one of that the bucket 5C of the work implement 5 reaches the soil removal target position 17R and that the operation device 7 is operated in the hoist revolving operation.

When a sixth transition condition is satisfied in a state where the down revolving operation is being performed in the automatic mode, the operation mode transitions from the automatic mode to the manual mode in which automatic control is permitted. The sixth transition condition includes at least one of that the bucket 5C of the work implement 5 reaches the excavation target position 16R and that the operation device 7 is operated in the down revolving operation.

When a seventh transition condition is satisfied in a state where the hoist revolving operation is being performed in the automatic mode, the operation mode transitions from the automatic mode to the manual mode in which automatic control is prohibited. The seventh transition condition includes that the second transition condition is satisfied, such as that the GNSS is unavailable.

When an eighth transition condition is satisfied in a state where the down revolving operation is being performed in the automatic mode, the operation mode transitions from the automatic mode to the manual mode in which automatic control is prohibited. The eighth transition condition includes that the second transition condition is satisfied, such as that the GNSS is unavailable.

The mode determination unit 145 can determine the operation mode of the revolving body 4 and the work implement 5 based on each of the first transition condition to the eighth transition condition.

### Control Method for Work Machine

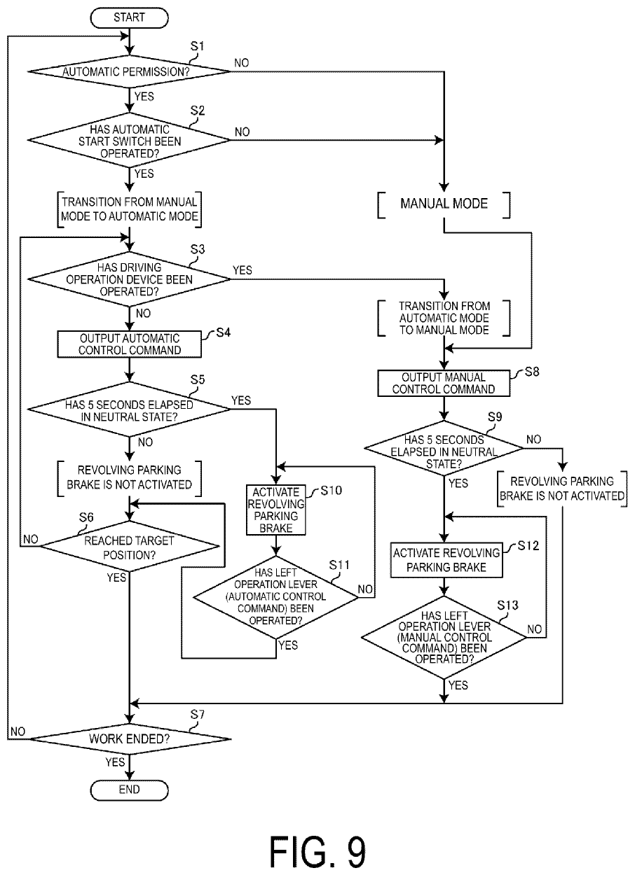

FIG. 9 is a flowchart showing the control method for the hydraulic excavator 1 according to the embodiment. In the manual mode, the automatic permission unit 144 determines whether or not the first transition condition described with reference to FIG. 8 is satisfied. In the embodiment, the automatic permission unit 144 determines whether automatic control is possible based on the operation state of the revolving lock switch 9A (step S1).

The automatic permission unit 144 permits the automatic control when the revolving lock switch 9A has not been operated. The automatic permission unit 144 prohibits the automatic control when the revolving lock switch 9A has been operated.

If it is determined in step S1 that the revolving lock switch 9A has not been operated, that is, when it is determined to permit the automatic control (step S1: Yes), the mode determination unit 145 determines whether or not the third transition condition or the fourth transition condition described with reference to FIG. 8 is satisfied. In the embodiment, if it is determined in step S1 to permit the automatic control, the mode determination unit 145 determines whether or not the automatic start switch 9D has been operated (step S2).

If it is determined in step S2 that the automatic start switch 9D is operated (step S2: Yes), the operation mode transitions from the manual mode to the automatic mode.

The mode determination unit 145 determines whether or not the fifth transition condition, the sixth transition condition, the seventh transition condition, or the eighth transition condition described with reference to FIG. 8 is satisfied. In the embodiment, the mode determination unit 145 determines whether or not the operation device 7 has been operated (step S3).

If it is determined in step S3 that the operation device 7 has not been operated (step S3: No), the automatic control command unit 147 outputs an automatic control command for the hoist revolving operation or the down revolving operation to the operation control unit 149 via the control command switching unit 148 (step S4).

The brake control unit 150 receives, via the control command switching unit 148, the automatic control command output from the automatic control command unit 147. The brake control unit 150 determines whether or not the automatic control command satisfies the brake activation condition. In the automatic mode, it is likely that an automatic control command corresponding to the neutral state of the left operation lever 7A is output from the automatic control command unit 147. In the automatic mode, it is likely that an automatic control command satisfying the brake activation condition is output from the automatic control command unit 147. The brake control unit 150 determines whether or not the automatic control command for revolving the revolving body 4 has been in the neutral state for 5 seconds (step S5).

If it is determined in step S5 that the automatic control command has not been in the neutral state for 5 seconds (step S5: No), the revolving parking brake 28 is not activated. The mode determination unit 145 determines whether or not the bucket 5C has reached the target position (the soil removal target position 17R or the excavation target position 16R) (step S6).

If it is determined in step S6 that the bucket 5C has not reached the target position (step S6: No), the process returns to step S3. If it is determined in step S6 that the bucket 5C has reached the target position (step S6: Yes), the mode determination unit 145 determines whether or not to end the work of the hydraulic excavator 1 (step S7).

If it is determined in step S7 to end the work of the hydraulic excavator 1 (step S7: Yes), the work of the hydraulic excavator 1 is ended. If it is determined in step S7 not to end the work of the hydraulic excavator 1 (step S7: No), the process returns to step S1.

If it is determined in step S1 that the revolving lock switch 9A is operated, that is, if it is determined to prohibit the automatic control (step S1: No), the manual mode is maintained. Also if it is determined in step S2 that the automatic start switch 9D has not been operated (step S2: No), the manual mode is maintained. If it is determined in step S3 that the operation device 7 is operated (step S3: Yes), the operation mode transitions from the automatic mode to the manual mode.

In the manual mode, the manual control command unit 146 generates the manual control command based on the operation signals from the left operation lever 7A and the right operation lever 7B. The manual control command unit 146 outputs, via the control command switching unit 148, the manual control command to each of the brake control unit 150 and the operation control unit 149 (step S8).

The brake control unit 150 receives, via the control command switching unit 148, the manual control command from the manual control command unit 146. The brake control unit 150 determines whether or not the manual control command for revolving the revolving body 4 has been in the neutral state for 5 seconds (step S9). The neutral state of the manual control command corresponds to the neutral state of the left operation lever 7A.

If it is determined in step S9 that the manual control command has not been in the neutral state for 5 seconds (step S9: No), the revolving parking brake 28 is not activated, and the process proceeds to step S7.

If it is determined in step S5 that the automatic control command has been in the neutral state for 5 seconds (step S5: Yes), the brake control unit 150 activates the revolving parking brake 28 (step S10).

The brake control unit 150 determines whether or not the left operation lever 7A operated to revolve the revolving body 4 has been operated (step S11).

If it is determined in step S11 that the left operation lever 7A has not been operated (step S11: No), the process returns to step S10, and the brake control unit 150 continues the activation of the revolving parking brake 28. If it is determined in step S11 that the left operation lever 7A has been operated (step S11: Yes), the activation of the revolving parking brake 28 is released, and the process proceeds to step S6.

If it is determined in step S9 that the manual control command has been in the neutral state for 5 seconds (step S9: Yes), the brake control unit 150 activates the revolving parking brake 28 (step S12).

The brake control unit 150 determines whether or not the left operation lever 7A operated to revolve the revolving body 4 has been operated (step S13).

If it is determined in step S13 that the left operation lever 7A has not been operated (step S13: No), the process returns to step S12, and the brake control unit 150 continues the activation of the revolving parking brake 28. If it is determined in step S13 that the left operation lever 7A has been operated (step S13: Yes), the activation of the revolving parking brake 28 is released, and the process proceeds to step S7.

### Computer System

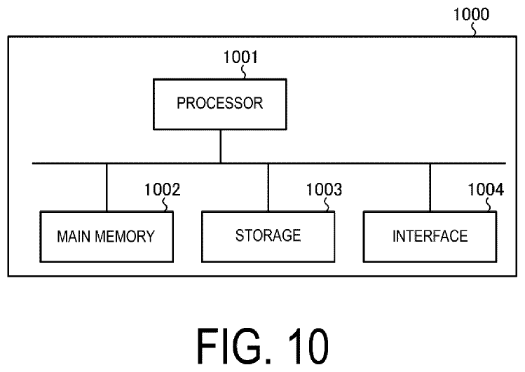

FIG. 10 is a block diagram illustrating a computer system 1000 according to the embodiment. The control device 14 described above includes the computer system 1000. The computer system 1000 includes a processor 1001 such as a central processing unit (CPU), a main memory 1002 including a non-volatile memory such as a read only memory (ROM) and a volatile memory such as a random access memory (RAM), a storage 1003, and an interface 1004 including an input/output circuit. The function of the control device 14 described above is stored in the storage 1003 as a computer program. The processor 1001 reads out the computer program from the storage 1003, deploys the computer program into the main memory 1002, and executes the above-described process in accordance with the program. Note that the computer program may be distributed to the computer system 1000 via a network.

The computer program or the computer system 1000 can execute outputting an automatic control command for automatically controlling the revolving body 4 and releasing actuation of the revolving parking brake 28 configured to stop revolving of the revolving body 4 in the automatic control of the revolving body 4 according to the above-described embodiment.

### Effects

As described above, according to the embodiment, the hydraulic excavator 1 includes the revolving body 4, the left operation lever 7A, which is the operation device 7 operated to revolve the revolving body 4, the revolving parking brake 28 configured to stop revolving of the revolving body 4, the automatic control command unit 147 that outputs the automatic control command for automatically controlling the revolving body 4, and the brake control unit 150 that controls the revolving parking brake 28 based on the operation state of the left operation lever 7A or the output state of the automatic control command.

According to the embodiment, in the manual mode, the revolving parking brake 28 is controlled based on the operation state of the left operation lever 7A. In the manual mode, the revolving parking brake 28 is activated when the operation state of the left operation lever 7A satisfies the brake activation condition. In the manual mode, since the revolving parking brake 28 is automatically activated when the operation state of the left operation lever 7A satisfies the brake activation condition, the revolving body 4 is suppressed from revolving. In the automatic mode, the revolving parking brake 28 is controlled based on the output state of the automatic control command. In the automatic mode, it is highly likely that the operator does not move the left operation lever 7A or releases the hand from the left operation lever 7A. That is, in the automatic mode, it is highly likely that the left operation lever 7A is brought into the neutral state. In the automatic mode, the revolving parking brake 28 is controlled not based on the operation state of the left operation lever 7A but based on the automatic control command output from the automatic control command unit 147. This suppresses the revolving parking brake 28 from being activated even when the left operation lever 7A is in the neutral state for a predetermined time in the automatic mode. Therefore, unnecessary operation for bringing the revolving parking brake 28 from the actuation state to the release state is no longer required, and a decrease in work efficiency of the hydraulic excavator 1 is suppressed. Even in a case where work in the manual operation mode and work in the automatic mode are mixed, a decrease in work efficiency is suppressed.

The control device 14 includes the manual control command unit 146 that generates a manual control command based on the operation signal from the left operation lever 7A, and the control command switching unit 148 to which the manual control command from the manual control command unit 146 and the automatic control command from the automatic control command unit 147 are input. In the manual mode, the control command switching unit 148 outputs the manual control command based on the operation signal of the operation device 7 to the brake control unit 150. In the manual mode, since the revolving parking brake 28 is automatically activated when the operation state of the left operation lever 7A satisfies the brake activation condition, the revolving body 4 is suppressed from revolving. The control command switching unit 148 outputs the automatic control command to the brake control unit 150 in the automatic mode. The revolving parking brake 28 is suppressed from being activated even when the left operation lever 7A is in the neutral state for a predetermined time in the automatic mode.

The hydraulic excavator 1 includes the automatic start switch 9D (automatic start input device) operated to start automatic control. When the automatic start switch 9D is operated in a state where the automatic control is permitted by the automatic permission unit 144, the automatic control command unit 147 outputs an automatic control command based on the input signal from the automatic start switch 9D. With the automatic control command being output from the automatic control command unit 147, the revolving body 4 and the work implement 5 are automatically controlled.

In the teaching process, the teaching unit 142 sets the excavation target position 16R at the object to be excavated 16 and sets the soil removal target position 17R at the object to receive removed soil 17. The target position storage unit 143 stores the excavation target position 16R set at the object to be excavated 16 and the soil removal target position 17R set at the object to receive removed soil 17. The automatic control command unit 147 outputs the automatic control command so that the bucket 5C of the work implement 5 moves to at least one of the excavation target position 16R and the soil removal target position 17R. In the embodiment, the automatic control command unit 147 outputs the automatic control command so that the bucket 5C moves to the soil removal target position 17R in the hoist revolving operation. The automatic control command unit 147 outputs the automatic control command so that the bucket 5C moves to the excavation target position 16R in the down revolving operation. This reduces the load on the operator.

### Other Embodiments

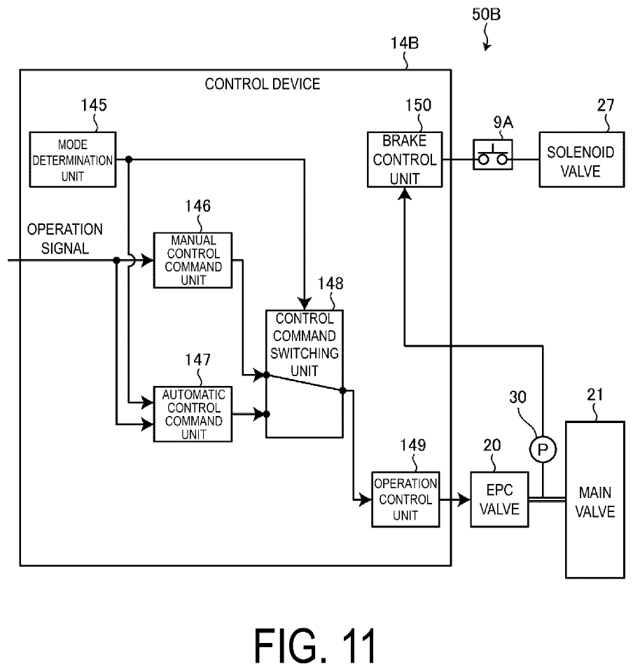

FIG. 11 is a block diagram illustrating a part of a control system 50B of the hydraulic excavator 1 according to another embodiment. As illustrated in FIG. 11, the brake control unit 150 may control the revolving parking brake 28 based on the pilot pressure applied to the main valve 21 by the EPC valve 20 (control valve). Similarly to the control device 14 described in the above-described embodiment, a control device 14B of the control system 50B includes the mode determination unit 145, the manual control command unit 146, the automatic control command unit 147, the control command switching unit 148, the operation control unit 149, and the brake control unit 150.

The mode determination unit 145 outputs a determined operation mode (manual mode or automatic mode) to each of the automatic control command unit 147 and the control command switching unit 148. Once the operation device 7 is operated by the operator, the operation signal is transmitted from the operation device 7 to each of the manual control command unit 146 and the automatic control command unit 147. The manual control command unit 146 outputs the manual control command to the control command switching unit 148 based on the operation signal from the operation device 7. The automatic control command unit 147 receives the operation mode determined by the mode determination unit 145. If the operation mode is the automatic mode, the automatic control command unit 147 outputs the automatic control command to the control command switching unit 148.

When the operation device 7 is operated by the operator in the automatic mode, it may be desired to control the operation of the revolving body 4 and the work implement 5 that are automatically controlled, by the operation signal from the operation device 7. For example, it may be desired to accelerate or decelerate revolving of the revolving body 4 automatically controlled or desired to accelerate or decelerate movement of the work implement 5 automatically controlled. When the operation device 7 is operated in the automatic control, the automatic control command unit 147 may generate and change a new automatic control command (automatic control command value) based on the operation signal from the operation device 7 operated by the operator. That is, the automatic control command may be a command changed by the operation of the operation device 7.

The control command switching unit 148 outputs any one of the manual control command and the automatic control command to the operation control unit 149 based on the operation mode determined by the mode determination unit 145. The control command switching unit 148 outputs the manual control command to the operation control unit 149 in the case of the manual mode, and outputs the automatic control command to the operation control unit 149 in the case of the automatic mode. The operation control unit 149 supplies the EPC valve 20 with the EPC current for driving the EPC valve 20. The EPC valve 20 applies pilot pressure to the spool of the main valve 21 based on the EPC current supplied from the operation control unit 149.

The pilot pressure applied to the main valve 21 by the EPC valve 20 is detected by the pressure sensor 30. In the manual mode, the brake control unit 150 activates the revolving parking brake 28 when the left operation lever 7A has been in the neutral state for 5 seconds. The brake control unit 150 may determine whether or not the brake activation condition is satisfied based on pilot pressure in the automatic mode. When the revolving body 4 is revolved in the automatic mode, the automatic control command unit 147 controls the EPC valve 20 so that the pilot pressure applied to the main valve 21 becomes a predetermined value or more. In the automatic mode, when the state in which the pilot pressure for revolving the revolving body 4 is not detected has lasted for 5 seconds, that is, when the state in which the pilot pressure detected by the pressure sensor 30 is less than a predetermined value has lasted for 5 seconds, the brake control unit 150 activates the revolving parking brake 28.

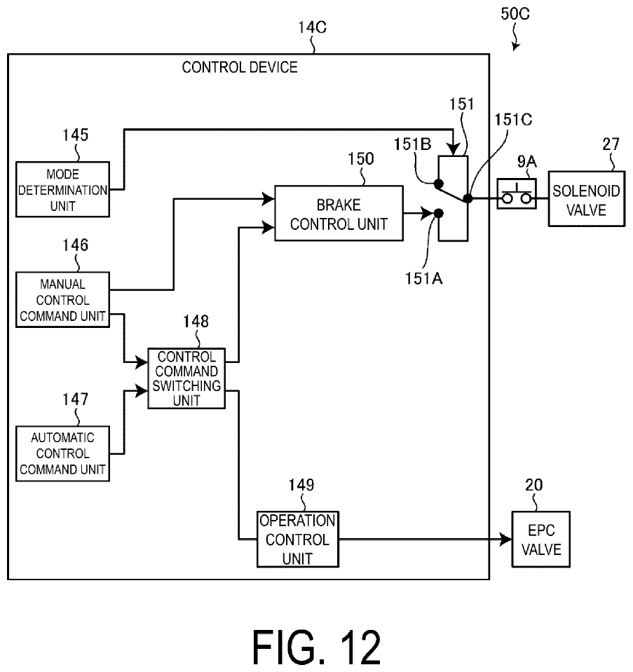

FIG. 12 is a block diagram illustrating a part of a control system 50C of the hydraulic excavator 1 according to another embodiment. As illustrated in FIG. 12, similarly to the control device 14 described in the above-described embodiment, a control device 14C of the control system 50C includes the mode determination unit 145, the manual control command unit 146, the automatic control command unit 147, the control command switching unit 148, the operation control unit 149, and the brake control unit 150. The control device 14C includes a switch unit 151. The switch unit 151 is activated based on the operation mode determined by the mode determination unit 145. The switch unit 151 is activated so that the manual control command generated based on the operation signal from the left operation lever 7A is transmitted to the revolving parking brake 28 in the manual mode, and a release command for releasing the activation of the revolving parking brake 28 is transmitted to the revolving parking brake 28 in the automatic mode. The switch unit 151 includes a brake command input unit 151A, a release command input unit 151B, and an output unit 151C. The brake command input unit 151A is connected to the brake control unit 150. The switch unit 151 switches between a state in which the brake command input unit 151A and the output unit 151C are connected and a state in which the release command input unit 151B and the output unit 151C are connected. In the manual mode, the brake command input unit 151A and the output unit 151C are connected. The brake control unit 150 outputs a manual control command to the solenoid valve 27 via the switch unit 151 so that the revolving parking brake 28 is activated when the left operation lever 7A has been in the neutral state for 5 seconds. In the automatic mode, the release command input unit 151B and the output unit 151C are connected. In the automatic mode, a release command for releasing the activation of the revolving parking brake 28 is output to the solenoid valve 27. That is, in the automatic mode, the revolving parking brake 28 is not activated. In the automatic mode, even when the left operation lever 7A has been in the neutral state for 5 seconds, the revolving body 4 can perform the hoist revolving operation or the down revolving operation based on the automatic control command from the automatic control command unit 147.

Note that if it is determined to be the automatic mode by determining whether or not to be the automatic mode, a release signal for releasing the revolving parking brake 28 may be output to the solenoid valve 27 regardless of the operation state of the revolving lock switch 9A.

In the above-described embodiment, the brake control unit 150 may control the revolving parking brake 28 based on a drive signal output from the operation control unit 149. As described above, in the manual mode, the operation control unit 149 outputs the drive signal for controlling the revolving body 4 (the EPC valve 20) based on the manual control command supplied from the control command switching unit 148. In the automatic mode, the operation control unit 149 outputs the drive signal for controlling the revolving body 4 (the EPC valve 20) based on the automatic control command supplied from the control command switching unit 148. The brake control unit 150 may control the revolving parking brake 28 based on the drive signal output from the operation control unit 149 in the manual mode. The brake control unit 150 may control the revolving parking brake 28 based on the drive signal output from the operation control unit 149 in the automatic mode. The revolving parking brake 28 may be controlled by pilot pressure based on the drive signal.

In the above-described embodiment, the excavation target position 16R, the soil removal target position 17R, and the intermediate target position 18R are set as a plurality of target positions of the bucket 5C in the automatic mode. The intermediate target position 18R needs not be set. In the above-described embodiment, in the teaching process, after the bucket 5C is placed at an arbitrary position by the operation of the left operation lever 7A and the right operation lever 7B, with the teaching switch 9C being operated, the target position is set. The positions of the object to be excavated 16 and the object to receive removed soil 17 may be detected by a three-dimensional sensor such as a laser sensor (light detection and ranging: LiDAR) or a stereo camera, for example, and the target position may be set based on the position detected by the three-dimensional sensor. In the teaching process, a target track of the bucket 5C may be set.

In the above-described embodiment, the orientation of the revolving body 4 is calculated based on the detection data of the first position sensor 11A and the detection data of the second position sensor 11B. An angle sensor that can detect the revolving angle of the revolving body 4 such as an encoder or a potentiometer may be mounted on the hydraulic excavator 1, and the orientation of the revolving body 4 may be calculated based on detection data of the angle sensor.

In the above-described embodiment, the revolving lock switch 9A may be disposed at the cab 2, and can be installed at an arbitrary position in the cab 2. A revolving lock input device operated to activate the revolving parking brake 28 may be provided in the in-vehicle monitor 8. The revolving lock input device may be, for example, a touch panel. The revolving lock input device may be provided in a tablet terminal. The revolving lock input device may be provided outside the cab 2. For example, the revolving lock input device may be disposed at a remote place of the hydraulic excavator 1, and the revolving parking brake 28 may be remotely operated. The same applies to the automatic permission switch 9B, the teaching switch 9C, and the automatic start switch 9D.

In the above-described embodiment, each of the position calculation unit 141, the teaching unit 142, the target position storage unit 143, the automatic permission unit 144, the mode determination unit 145, the manual control command unit 146, the automatic control command unit 147, the control command switching unit 148, the operation control unit 149, the brake control unit 150, and the switch unit 151 may be configured by separate hardware.

In the above-described embodiment, the work machine 1 is a hydraulic excavator including the traveling body 3, the revolving body 4, and the work implement 5. The work machine 1 may have the revolving body 4.

In the above-described embodiment, the revolving body 4 may be revolved by an electric revolving motor.

In the above-described embodiment, the work machine 1 may be a hybrid excavator or an electric excavator. The work machine 1 may be a rope excavator.

In the above-described embodiment, the operation mode of the excavation operation and the operation mode of the soil removal operation are the manual mode. The operation mode of the excavation operation and the operation mode of the soil removal operation may be the automatic mode.

In the above-described embodiment, the operation mode of the hoist revolving operation and the operation mode of the down revolving operation are the automatic mode. One operation mode of the operation mode of the hoist revolving operation and the operation mode of the down revolving operation may be the automatic mode, and the other operation mode may be the manual mode.

In the above-described embodiment, the intermediate target position 18R needs not be set when the soil removal target position 17R is set so as not to cause interference between the bucket 5C and the object to receive removed soil 17.

In the above-described embodiment, the automatic permission switch 9B may be omitted.

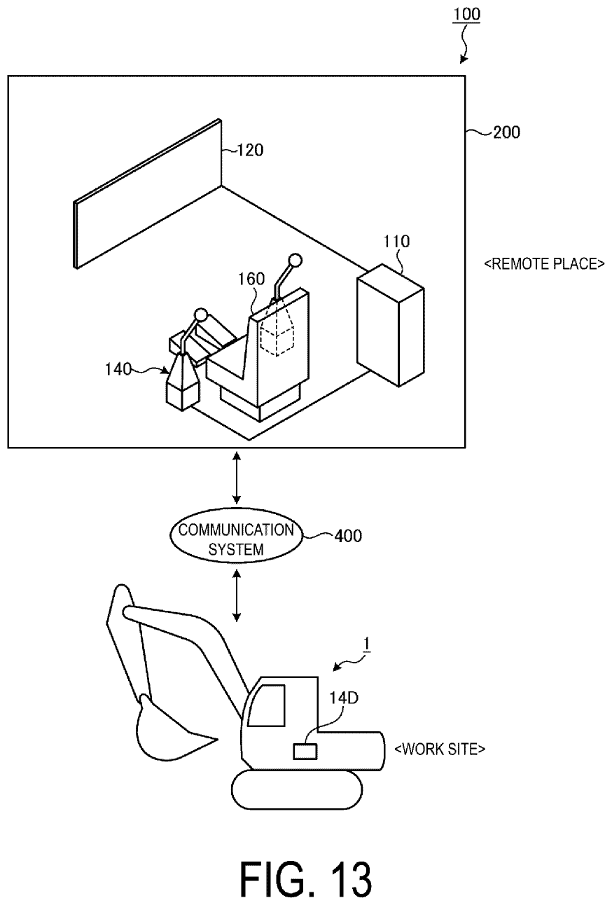

In the above-described embodiment, the work machine 1 may be remotely operated. FIG. 13 is a schematic view illustrating a remote operation system 100 of the work machine 1 according to another embodiment. The remote operation system 100 remotely operates the work machine 1 that works at the work site. The remote operation system 100 includes the control system (50, 50B, or 50C) described above. At least a part of the remote operation system 100 is disposed in a remote operation chamber 200 outside the work machine 1. The remote operation chamber 200 is installed at a remote place away from the work site.

The remote operation system 100 includes a remote operation device 140, a display device 120, and a controller 110. The remote operation device 140 is disposed in the remote operation chamber 200. The remote operation device 140 is operated by the operator in the remote operation chamber 200. The operator can operate the remote operation device 140 in a state of being seated on an operator seat 160. The remote operation device 140 generates an operation signal for operating the work implement 5 and the revolving body 4 by being operated by the operator.

The display device 120 is disposed in the remote operation chamber 200. The display device 120 displays an image of the work site. The operator in the remote operation chamber 200 can visually recognize the situation of the work site via the display device 120. The operator operates the remote operation device 140 while viewing the image of the work site displayed on the display device 120. The work machine 1 is remotely operated by the remote operation device 140.

The controller 110 is disposed in the remote operation chamber 200. The controller 110 includes a computer system. The work machine 1 includes a control device 14D. The control device 14D includes a computer system. The controller 110 and the control device 14D communicate with each other via a communication system 400. Examples of the communication system 400 include the Internet, a local area network (LAN), a mobile phone communication network, and a satellite communication network. The communication system 400 may include a relay station that relays data to be communicated.

### REFERENCE SIGNS LIST

1 Hydraulic excavator (work machine), 2 Cab, 3 Traveling body, 3A Continuous track, 4 Revolving body, 5 Work implement, 5A Boom, 5B Arm, 5C Bucket, 6 Hydraulic cylinder, 6A Boom cylinder, 6B Arm cylinder, 6C Bucket cylinder, 7 Operation device, 7A Left operation lever, 7B Right operation lever, 7C Left travel lever, 7D Right travel lever, 7E Left foot pedal, 7F Right foot pedal, 7G Operation pedal, 8 In-vehicle monitor, 8A Display device, 8B Input device, 9 Input device, 9A Revolving lock switch (revolving lock input device), 9B Automatic permission switch, 9C Teaching switch, 9D Automatic start switch (automatic start input device), 10 Lock lever (operation lock operation device), 11 Position sensor, 11A First position sensor, 11B Second position sensor, 12 Inertial sensor, 13 Posture sensor, 13A Boom posture sensor, 13B Arm posture sensor, 13C Bucket posture sensor, 14 Control device, 14B Control device, 14C Control device, 14D Control device, 15 Operator seat, 16 Object to be excavated, 16R Excavation target position, 17 Object to receive removed soil, 17R Soil removal target position, 18R Intermediate target position, 19A First route, 19B Second route, 20 EPC valve (control valve), 21 Main valve, 22 Engine, 23 Hydraulic pump, 24 Revolving motor, 25 Brake disc, 26 Brake cylinder, 27 Solenoid valve, 28 Revolving parking brake, 30 Pressure sensor, 50 Control system, 50B Control system, 50C Control system, 141 Position calculation unit, 100 Remote operation system, 110 Controller, 120 Display device, 140 Remote operation device, 142 Teaching unit, 143 Target position storage unit, 144 Automatic permission unit, 145 Mode determination unit, 146 Manual control command unit, 147 Automatic control command unit, 148 Control command switching unit, 149 Operation control unit, 150 Brake control unit, 151 Switch unit, 151A Brake command input unit, 151B Release command input unit, 151C Output unit, 160 Operator seat, 200 Remote operation chamber, 400 Communication system, 1000 Computer system, 1001 Processor, 1002 Main memory, 1003 Storage, 1004 Interface, Og Site reference point, Om Representative point, RX Axis of revolution.

1. A control system for a work machine, the control system comprising:
a revolving body;
an operation device operable to revolve the revolving body;
a revolving parking brake configured to stop revolving of the revolving body;
an automatic control command generator configured to output an automatic control command for automatically controlling the revolving body; and
a brake controller configured to control the revolving parking brake based on an operation state of the operation device or an output state of the automatic control command.

2. The control system for a work machine according to claim 1, wherein
the automatic control command is a command not based on an operation of the operation device.

3. The control system for a work machine according to claim 1, wherein
the automatic control command is a command changed by an operation of the operation device.

4. The control system for a work machine according to claim 1, the control system further comprising an operation controller configured to control the revolving body based on the automatic control command.

5. The control system for a work machine according to claim 4, wherein
the brake controller actuates the revolving parking brake when an output state of the automatic control command satisfies a brake activation condition.

6. The control system for a work machine according to claim 1, wherein
the brake controller actuates the revolving parking brake when an operation state of the operation device satisfies a brake activation condition in a manual mode in which the automatic control command is not output.

7. The control system for a work machine according to claim 1, the control system further comprising:
a hydraulic motor configured to revolve the revolving body;
a main valve configured to adjust a direction and a flow rate of hydraulic oil supplied to the hydraulic motor;
a control valve configured to apply, to the main valve, pilot pressure for moving a spool of the main valve; and
an operation controller configured to output a drive signal for controlling the revolving body based on the automatic control command,
wherein
the brake controller controls the revolving parking brake based on the drive signal output from the operation controller.

8. The control system for a work machine according to claim 7, wherein
the revolving parking brake is controlled by the pilot pressure based on the drive signal.

9. The control system for a work machine according to claim 1, the control system further comprising an automatic start input device operable to start the automatic control, wherein
the automatic control command generator outputs the automatic control command when the automatic start input device is operated.

10. The control system for a work machine according to claim 9, the control system further comprising:
a work implement attached to the revolving body; and
a target position storage configured to store an excavation target position set as an object to be excavated,
wherein
the automatic control command generator outputs the automatic control command to move a bucket of the work implement to the excavation target position.

11. The control system for a work machine according to claim 9, the control system further comprising:
a work implement attached to the revolving body; and
a target position storage configured to store a soil removal target position set as an object to receive removed soil,
wherein
the automatic control command generator outputs the automatic control command to move a bucket of the work implement to the soil removal target position.

12. A control method for a work machine, the control method comprising:
outputting an automatic control command for automatically controlling a revolving body;
and
controlling an operation of a revolving parking brake configured to stop revolving of the revolving body based on an output state of the automatic control command.
